(19) United States
(12) Patent Application Publication
(10) Pub. No.: US 2019/0057804 A1
(43) Pub. Date: Feb. 21, 2019

(54) DRY-TYPE TRANSFORMER COIL AND A WINDING METHOD THEREFOR

(71) Applicant: Tritype Electric Co., Ltd., Jiangmen (CN)

(72) Inventors: Kaixuan Xu, Jiangmen (CN); Yuxiang Qi, Jiangmen (CN)

(73) Assignee: Tritype Electric Co., Ltd., Jiangmen (CN)

(21) Appl. No.: 15/756,887

(22) PCT Filed: Apr. 20, 2017
(86) PCT No.: PCT/CN2017/081164

§ 371 Date: Mar. 1, 2018

(30) Foreign Application Priority Data
Mar. 29, 2017 (CN) 201710197291.1

(51) Int. Cl. H01F 27/28; H01F 41/061; H01F 27/32

(52) U.S. Cl. CPC H01F 27/2876; H01F 27/32; H01F 41/061; H01F 27/2871

(57) ABSTRACT

A dry-type transformer coil and a method of winding a dry-type transformer coil are disclosed. The dry-type transformer coil includes an inner cylinder and at least two layers of pancake coils. The pancake coils are wound around the inner cylinder sequentially along an axial direction of the inner cylinder. Each layer of pancake coils includes an inner coil and an outer coil. The inner coil is separated from the outer coil to form a first air passage, and provided with a first spacer block for separating the inner coil from the outer coil. Adjacent layers of pancake coils are separated from each other to form a second air passage, and provided with a second spacer block for separating respective inner coils of the adjacent two layers of pancake coils from each other, and a third spacer block for separating respective outer coils of the adjacent two layers of pancake coils from each other.

### TECHNICAL FIELD

The present disclosure relates to the technical field of transformer, and more particularly, to a dry-type transformer coil and a method of winding a dry-type transformer coil.

### BACKGROUND

A dry-type transformer refers to a transformer with an iron core and a coil where the iron core and the coil are not immersed in insulating oil. In recent years, the dry-type transformer has been widely used in various applications due to its characteristic of low noise, easy installation, low loss and the safe operation. The coil of the dry-type transformer will generate a certain amount of heat during operation. If the heat cannot be dissipated in time, the operational reliability of the coil of the dry-type transformer will be affected, and the service life will be greatly reduced. Thus the effective heat dissipation of the coils must be ensured.

SUMMARY

Based on the above, in order to overcome the defects in the prior art, a dry-type transformer coil and a method of winding a dry-type transformer coil are provided here, which can effectively improve heat dissipation capacity and ensure safe and reliable operation.

A dry-type transformer coil is provided, including an inner cylinder and at least two layers of pancake coils. The at least two layers of pancake coils are wound around the inner cylinder sequentially along an axial direction of the inner cylinder. Each layer of pancake coils includes an inner coil and an outer coil. The inner coil is separated from the outer coil to form a first air passage, and the first air passage is provided with a first spacer block for separating the inner coil from the outer coil. Adjacent two layers of pancake coils are separated from each other to form a second air passage, and the second air passage is provided with a second spacer block for separating respective inner coils of the adjacent two layers of pancake coils from each other, and a third spacer block for separating respective outer coils of the adjacent two layers of pancake coils from each other.

In the above dry-type transformer coil, the inner coil and the outer coil of each layer of pancake coils are separated from each other by the first spacer block, to form the first air passage. The respective inner coils of the adjacent two layers of pancake coils are separated from each other by the second spacer block, and the respective outer coils of the adjacent two layers of pancake coils are separated from each other by the third spacer block, to form the second air passage. The first air passage cooperates with the second air passage so that heat caused by operation of the pancake coils can be effectively and quickly dissipated, thereby improving operational reliability of the dry-type transformer coil and increasing service life of the dry-type transformer coil. The dry-type transformer coil can effectively improve heat dissipation capacity, and ensure the safe and reliable operation.

In one embodiment, the second spacer block and the third spacer block are integrally formed. Since the second spacer block and the third spacer block are integrally formed, the arrangement of the second spacer block and the third spacer block can be implemented at the same time, with a more compact configuration, which is more convenient for installation.

In one embodiment, there are at least two first spacer blocks, and the at least two first spacer blocks are arranged along a circumferential direction of the inner cylinder and evenly separated from each other. There are at least two second spacer blocks, and the at least two second spacer blocks are arranged along the circumferential direction of the inner cylinder and evenly separated from each other. There are at least two third spacer blocks, and the at least two third spacer blocks are arranged along the circumferential direction of the inner cylinder and evenly separated from each other. In this way, the pancake coils have better evenness in winding, which is convenient for winding and good for winding quality.

In one embodiment, each of the inner cylinder, the first spacer block, the second spacer block and the third spacer block is made of an insulating material, which is favorable for improving insulation performance and operational reliability of the dry-type transformer coil.

In one embodiment, the inner coil is separated from the inner cylinder to form a third air passage, and the third air passage is provided with a fourth spacer block for separating the inner coil from the inner cylinder. Since the inner coil of each layer of pancake coils is separated from the inner cylinder by the fourth spacer block to form the third air passage, the heat dissipation capability can be further improved.

In one embodiment, there are at least two fourth spacer blocks, and the at least two fourth spacer blocks are arranged along a circumferential direction of the inner cylinder and evenly separated from each other. In this way, the pancake coils have better evenness in winding, which is convenient for winding and good for winding quality.

In one embodiment, the fourth spacer block is made of an insulating material, which is favorable for improving the insulation performance and operational reliability of the dry-type transformer coil.

In one embodiment, the dry-type transformer coil further includes an outer cylinder arranged outside the pancake coils to protect the pancake coil so as to improve operational reliability of the dry-type transformer coil and increase service life of the dry-type transformer coil.

In one embodiment, the outer cylinder is made of an insulating material, which is favorable for improving insulation performance and operational reliability of the dry-type transformer coil.

A method of winding a dry-type transformer coil is also provided here, including following steps:

(1) winding an inner coil of a previous layer of pancake coils around an inner cylinder, providing a first spacer block at an side of the inner coil of the previous layer of pancake coils for separating the inner coil of the previous layer of pancake coils from an outer coil of the previous layer of pancake coils, winding the outer coil of the previous layer of pancake coils around the first spacer block, and forming a first air passage between the inner coil of the previous layer of pancake coils and the outer coil of the previous layer of pancake coils;

(2) providing a second spacer block at an end of the inner coil of the previous layer of pancake coils for separating the inner coil of the previous layer of pancake coils from an inner coil of a next layer of pancake coils, providing a third spacer block at an end of the outer coil of the previous layer of pancake coils for separating the outer coil of the previous layer of pancake coils from an outer coil of the next layer of pancake coils, winding the inner coil of the next layer of pancake coils around the inner cylinder, providing a further first spacer block at a side of the inner coil of the next layer of pancake coils for separating the inner coil of the next layer of pancake coils from the outer coil of the next layer of pancake coils, winding the outer coil of the next layer of pancake coils around the further first spacer block, forming a further first air passage between the inner coil of the next layer of pancake coils and the outer coil of the next layer of pancake coils, and forming a second air passage between the inner coil of the previous layer of pancake coils and the inner coil of the next layer of pancake coils, and between the outer coil of the previous layer of pancake coils and the outer coil of the next layer of pancake coils; and

repeating the above step (2) until a last layer of pancake coils has been wound.

For the above method of winding the dry-type transformer coil, the inner coil and the outer coil of each layer of pancake coils are separated from each other by the first spacer block, to form the first air passage. The respective inner coils of the adjacent two layers of pancake coils are separated from each other by the second spacer block, and the respective outer coils of the adjacent two layers of pancake coils are separated from each other by the third spacer block, to form the second air passage. The first air passage cooperates with the second air passage so that the heat caused by operation of the pancake coils can be effectively and quickly dissipated, thereby improving operational reliability of the dry-type transformer coil and increasing service life of the dry-type transformer coil. The method of winding the dry-type transformer coil can effectively improve heat dissipation capacity and ensure safe and reliable operation.

### BRIEF DESCRIPTION OF DRAWINGS

FIG. 1 is a structural schematic diagram illustrating a dry-type transformer coil according to one embodiment of the present disclosure.

FIG. 2 is a cross-sectional schematic diagram of a dry-type transformer coil according to one embodiment of the present disclosure.

### DESCRIPTION OF REFERENCE NUMERALS

100: inner cylinder; 200: pancake coil; 210: inner coil; 220: outer coil; 300: first spacer block; 400: second spacer block; 500: third spacer block; 600: fourth spacer block; 700: first air passage; 800: second air passage; and 900: third air passage.

### DETAILED DESCRIPTION OF THE PREFERRED EMBODIMENT

The present disclosure will now be described more fully hereinafter with reference to the accompanying drawings, in which preferred embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

It will be understood that when an element is herein referred to as being “on” another element, it can be directly on the other element or intervening elements may also be present. When an element is referred to as being “connected” to another element, it can be directly connected to the other element or intervening elements may be present at the same time. In contrast, when an element is referred to as being “directly on” another element, there exist no centered elements. The terms “vertical”, “horizontal”, “left”, “right” and similar expression used herein are for illustrative purposes only and do not represent the only embodiments.

Unless otherwise defined, all technical and scientific terms used herein have the same meaning as commonly understood by a person skilled in the art to which this disclosure belongs. The terminology used herein is for the purpose of describing particular embodiments only, and is not intended to limit the present disclosure. As used herein, the term “and/or” comprises any and all combinations of one or more of the associated listed items.

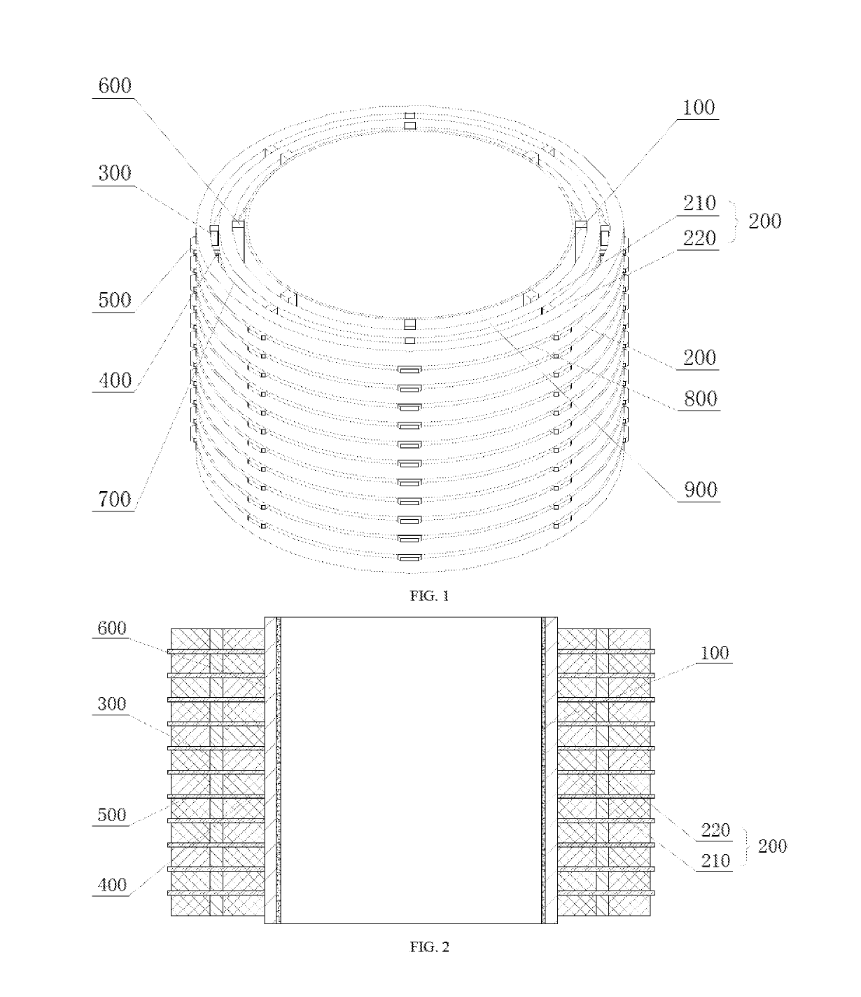

As shown in FIGS. 1-2, in this embodiment, the dry-type transformer coil includes an inner cylinder 100 and at least two layers of pancake coils 200. The at least two layers of pancake coils 200 are wound around the inner cylinder 100 sequentially along an axis of the inner cylinder 100. Each layer of pancake coils 200 includes an inner coil 210 and an outer coil 220. The inner coil 210 is separated from the outer coil 220 to form a first air passage 700, and the first air passage 700 is provided with a first spacer block 300 for separating the inner coil 210 from the outer coil 220. Adjacent two layers of pancake coils 200 are separated from each other to form a second air passage 800, and the second air passage 800 is provided with a second spacer block 400 for separating respective inner coils 210 of the adjacent two layers of pancake coils 200 from each other, and a third spacer block 500 for separating respective outer coils 220 of the adjacent two layers of pancake coils 200 from each other.

In the above dry-type transformer coil, the inner coil 210 and the outer coil 220 of each layer of pancake coils 200 are separated from each other by the first spacer block 300, to form the first air passage 700. The respective inner coils 210 of the adjacent two layers of pancake coils 200 are separated from each other by the second spacer block 400, and the respective outer coils 220 of the adjacent two layers of pancake coils 200 are separated from each other by the third spacer block 500 to form the second air passage 800. The first air passage 700 cooperates with the second air passage 800 so that heat caused by operation of pancake coils 200 can be effectively and rapidly dissipated to improve operational reliability of the dry-type transformer coil and increase service life of the dry-type transformer coil. The dry-type transformer coil can effectively improve heat dissipation capacity, and ensure safe and reliable operation.

In addition, since the first air passage 700 of the dry-type transformer coil can cooperate with the second air passage 800 of the dry-type transformer coil to substantially meet heat dissipation requirements, the size of the second air passage 800 can be appropriately reduced when designing the dry-type transformer coil so that the overall height of the dry-type transformer coil can be reduced to achieve the purpose of saving materials.

The second spacer block 400 and the third spacer block 500 are integrally formed. Since the second spacer block 400 and the third spacer block 500 are integrally formed, the arrangement of the second spacer block 400 and the third spacer block 500 can be implemented at the same time, with a more compact configuration, which is more convenient for installation.

In this embodiment, the inner coil 210 is separated from the inner cylinder 100 to form a third air passage 900. The third air passage 900 is provided with a fourth spacer block 600 for separating the inner coil 210 from the inner cylinder 100. Since the inner coil 210 of each layer of pancake coils 200 is separated from the inner cylinder 100 by the fourth spacer block 600 to form the third air passage 900, the heat dissipation capability can be further improved.

Preferably, there are at least two spacer blocks 300, and the at least two first spacer blocks 300 are arranged along a circumferential direction of the inner cylinder 100 and evenly separated from each other. There are at least two the second spacer blocks 400, and the at least two second spacer blocks 400 are arranged along a circumferential direction of the inner cylinder 100 and evenly separated from each other. There are at least two third spacer blocks 500, and the at least two third spacer blocks 500 are arranged along a circumferential direction of the inner cylinder 100 and evenly separated from each other. In this way, the pancake coils 200 have better evenness in winding, which is convenient for winding and good for winding quality.

Specifically, two sides of the first spacer block 300 respectively abut on the inner coil 210 and the outer coil 220. Two ends of the second spacer block 400 respectively abut on respective inner coils 210 of the adjacent two layers of pancake coils 200. Two ends of the third spacer block 500 respectively abut on respective outer coils 220 of the adjacent two layers of pancake coils 200. The first spacer block 300, the second spacer block 400, and the third spacer block 500 are easy to assemble and disassemble, and have good separation effect.

In this embodiment, there are eight first spacer blocks 300 in each first air passage 700, there are eight second spacer blocks 400 in each second air passages 800, and there are eight third spacer blocks 500 in each second air passages 800. The first spacer block 300, the second spacer block 400, and the third spacer block 500 are arranged in a one-to-one correspondence. In this way, each of the first air passage 700 and the second air passage 800 is divided into eight equal parts, the electric field distribution is uniform, and the stability of the dry-type transformer coil is improved.

Preferably, there are at least two fourth spacer blocks 600, and the at least two fourth spacer blocks 600 are arranged along a circumferential direction of the inner cylinder 100 and evenly separated from each other. In this way, the pancake coils 200 have better evenness in winding, which is convenient for winding and good for winding quality. In this embodiment, there are eight fourth spacer blocks 600 in the third channel 900.

Specifically, two sides of the fourth spacer block 600 respectively abut on the inner coil 210 and the inner cylinder 100. The assembly and disassembly of the fourth spacer block 600 is convenient and the separation effect is good.

Further, each of the inner cylinder 100, the first spacer block 300, the second spacer block 400, the third spacer block 500 and the fourth spacer block 600 is made of an insulating material, which is favorable for improving the insulation performance of the dry-type transformer coil, resulting in high operational reliability.

In this embodiment, the dry-type transformer coil further comprises an outer cylinder (not shown) arranged outside the pancake coil 200 for protecting the pancake coil 200 so as to improve the operational reliability of the dry-type transformer coil and increase the service life of dry-type transformer coil. The outer cylinder is made of an insulating material, which is favorable for improving the insulation performance of the dry-type transformer coil and, resulting in high operational reliability.

Combining with FIG. 1-2, a method of winding a dry-type transformer coil is also provided in this embodiment. The method includes the following steps.

(1) winding an inner coil 210 of a first layer of pancake coils 200 around an inner cylinder 100, providing a first spacer block 300 at an side of the inner coil 210 of the first layer of pancake coils 200 for separating the inner coil 210 of the first layer of pancake coils 200 from an outer coil 220 of the first layer of pancake coils 200, winding the outer coil 220 of the first layer of pancake coils 200 around the first spacer block 300, and forming a first air passage 700 between the inner coil 210 of the first layer of pancake coils 200 and the outer coil 220 of the first layer of pancake coils 200;

(2) providing a second spacer block 400 at an end of the inner coil 210 of the first layer of pancake coils 200 for separating the inner coil 210 of the first layer of pancake coils 200 from an inner coil 210 of a second layer of pancake coils 200, providing a third spacer block 500 at an end of the outer coil 220 of the first layer of pancake coils 200 for separating the outer coil 220 of the first layer of pancake coils 200 from an outer coil 220 of the second layer of pancake coils 200, winding the inner coil 210 of the second layer of pancake coils 200 around the inner cylinder 100, providing a further first spacer block 300 at a side of the inner coil 210 of the second layer of pancake coils 200 for separating the inner coil 210 of second layer of pancake coils 200 from the outer coil 220 of the second layer of pancake coils 200, winding the outer coil 220 of the second layer of pancake coils 200 around the further first spacer block 300, forming a further first air passage 700 between the inner coil 210 of the second layer of pancake coils 200 and the outer coil 220 of the second layer of pancake coils 200, and forming a second air passage 800 between the inner coil 210 of the first layer of pancake coils 200 and the inner coil 210 of the second layer of pancake coils 200, and between the outer coil 220 of the first layer of pancake coils 200 and the outer coil of the second layer of pancake coils 200;

(3) providing a further second spacer block 400 at an end of the inner coil 210 of the second layer of pancake coils 200 for separating the inner coil 210 of the second layer of pancake coils 200 from an inner coil 210 of a third layer of pancake coils 200, providing a further third spacer block 500 at an end of the outer coil 220 of the second layer of pancake coils 200 for separating the outer coil 220 of the second layer of pancake coils 200 from an outer coil 220 of the third layer of pancake coils 200, winding the inner coil 210 of the third layer of pancake coils 200 around the inner cylinder 100, providing a further first spacer block 300 at a side of the inner coil 210 of the third layer of pancake coils 200 for separating the inner coil 210 of third layer of pancake coils 200 from the outer coil 220 of the third layer of pancake coils 200, winding the outer coil 220 of the third layer of pancake coils 200 around the further first spacer block 300, forming a further first air passage 700 between the inner coil 210 of the third layer of pancake coils 200 and the outer coil 220 of the third layer of pancake coils 200, and forming a further second air passage 800 between the inner coil 210 of the second layer of pancake coils 200 and the inner coil 210 of the third layer of pancake coils 200, and between the outer coil 220 of the second layer of pancake coils 200 and the outer coil of the third layer of pancake coils 200; and

(4) repeating the above step in the same manner until a last layer of pancake coils 200 has been wound. In this embodiment, the last layer of pancake coils 200 is a twelfth layer of pancake coils 200.

For the above method of winding the dry-type transformer coil, the inner coil 210 and the outer coil 220 of each layer of pancake coils 200 are separated from each other by the first spacer block 300, to form the first air passage 700. The respective inner coils 210 of the adjacent two layers of pancake coils 200 are separated from each other by the second spacer block 400, and the respective outer coils 220 of the adjacent two layers of pancake coils 200 are separated from each other by the third spacer block 500, to form the second air passage 800. The first air passage 700 cooperates with the second air passage 800 so that the heat caused by operation of the pancake coils 200 can be effectively and quickly dissipated, thereby improving operational reliability of the dry-type transformer coil and increasing service life of the dry-type transformer coil. The method of winding the dry-type transformer coil can effectively improve heat dissipation capacity and ensure safe and reliable operation.

Each technical feature in the above embodiments can be combined in any way, and for the purpose of concise description, not all possible combinations of each technical feature in the above embodiments have been described, however, these combinations of each technical feature all belong to the scope of the present description as long as no contradiction exists.

The above embodiments have only shown certain modes of extrusion of the present disclosure, which is described more specifically and in detail, but it cannot be considered as limit to the scope of the present disclosure. It should be noted that, for those skilled in the art, this embodiments may have various variants and modifications without departing from the present inventive ideas and concept, all of which belong to the protection scope of the present disclosure. Thus, the protection scope of the present disclosure subjects to the attached claims

1. A dry-type transformer coil, comprising an inner cylinder and at least two layers of pancake coils, wherein the at least two layers of pancake coils are wound around the inner cylinder sequentially along an axial direction of the inner cylinder, each layer of pancake coils includes an inner coil and an outer coil, the inner coil is separated from the outer coil to form a first air passage, the first air passage is provided with a first spacer block for separating the inner coil from the outer coil, adjacent two layers of pancake coils are separated from each other to form a second air passage, the second air passage is provided with a second spacer block for separating respective inner coils of the adjacent two layers of pancake coils from each other, and a third spacer block for separating respective outer coils of the adjacent two layers of pancake coils from each other.

2. The dry-type transformer coil according to claim 1, wherein the second spacer block and the third spacer block are integrally formed.

3. The dry-type transformer coil according to claim 1, wherein there are at least two first spacer blocks, and the at least two first spacer blocks are arranged along a circumferential direction of the inner cylinder and evenly separated from each other. There are at least two second spacer blocks, and the at least two second spacer blocks are arranged along the circumferential direction of the inner cylinder and evenly separated from each other. There are at least two third spacer blocks, and the at least two third spacer blocks are arranged along the circumferential direction of the inner cylinder and evenly separated from each other.

4. The dry-type transformer coil according to claim 1, wherein each of the inner cylinder, the first spacer block, the second spacer block and the third spacer block is made of an insulating material.

5. The dry-type transformer coil according to claim 1, wherein the inner coil is separated from the inner cylinder to form a third air passage, and the third air passage is provided with a fourth spacer block for separating the inner coil from the inner cylinder.

6. The dry-type transformer coil according to claim 5, wherein there are at least two fourth spacer blocks, and the at least two fourth spacer blocks are arranged along a circumferential direction of the inner cylinder and evenly separated from each other.

7. The dry-type transformer coil according to claim 5, wherein the fourth spacer block is made of an insulating material.

8. The dry-type transformer coil according to claim 1, further comprising an outer cylinder arranged outside the pancake coils.

9. The dry-type transformer coil according to claim 8, wherein the outer cylinder is made of an insulating material.

10. A method of winding a dry-type transformer coil, comprising following steps:
(1) winding an inner coil of a previous layer of pancake coils around an inner cylinder, providing a first spacer block at an side of the inner coil of the previous layer of pancake coils for separating the inner coil of the previous layer of pancake coils from an outer coil of the previous layer of pancake coils, winding the outer coil of the previous layer of pancake coils around the first spacer block, and forming a first air passage between the inner coil of the previous layer of pancake coils and the outer coil of the previous layer of pancake coils;
(2) providing a second spacer block at an end of the inner coil of the previous layer of pancake coils for separating the inner coil of the previous layer of pancake coils from an inner coil of a next layer of pancake coils, providing a third spacer block at an end of the outer coil of the previous layer of pancake coils for separating the outer coil of the previous layer of pancake coils from an outer coil of the next layer of pancake coils, winding the inner coil of the next layer of pancake coils around the inner cylinder, providing a further first spacer block at a side of the inner coil of the next layer of pancake coils for separating the inner coil of the next layer of pancake coils from the outer coil of the next layer of pancake coils, winding the outer coil of the next layer of pancake coils around the further first spacer block, forming a further first air passage between the inner coil of the next layer of pancake coils and the outer coil of the next layer of pancake coils, and forming a second air passage between the inner coil of the previous layer of pancake coils and the inner coil of the next layer of pancake coils, and between the outer coil of the previous layer of pancake coils and the outer coil of the next layer of pancake coils; and
repeating the above step (2) until a last layer of pancake coils has been wound.
